(19) United States
(12) Patent Application Publication
(10) Pub. No.: US 2026/0031728 A1
(43) Pub. Date: Jan. 29, 2026

(54) MULTIPHASE CONTROLLER WITH INDEPENDENTLY ADJUSTABLE POWER STAGE

(71) Applicant: Alpha and Omega Semiconductor International LP, Toronto (CA)

(72) Inventors: Ashwini Ravindran, Campbell, CA (US); Sitthipong Angkititraku, Dublin, CA (US); Nicholas Archibald, San Francisco, CA (US); Rhys Philbrick, Los Gatos, CA (US)

(73) Assignee: Alpha and Omega Semiconductor International LP, Toronto (CA)

(21) Appl. No.: 18/785,913

(22) Filed: Jul. 26, 2024

(51) Int. Cl. H02M 3/158; H02M 1/00

(52) U.S. Cl. CPC H02M 3/1584; H02M 1/0009; H02M 1/0032

(57) ABSTRACT

Apparatus and associated methods relate to a multi-mode multi-phase power control circuit (MMPC). In an illustrative example, the MMPC includes a scalable power phase (SPP) and at least one main power phase (MPP). The SPP, for example, may include a scaled inductor configured to enhance power efficiency in a low power mode. A power controller operably connected to the SPP and the MPP may generate a control signal to the SPP as a function of a user-defined scaling model including an output current scaling factor associated with a current mode of operation. For example, the SPP may be configured as a function of the scaling model, as a full current phase, a partial current phase, or a minimal current phase. Various embodiments may advantageously provide independently regulated power phases having a predetermined fraction of a current output of the MPP.

### TECHNICAL FIELD

Various embodiments relate generally to power electronics including, for example, a multiphase DC-DC converter.

### BACKGROUND

Multiphase DC-DC power converters are a type of power electronics configured to convert a source of direct current (DC) from one voltage level to another using multiple interleaved phases. Various applications, for example, including portable electronic devices, electric vehicles, computers, communication equipment, and other DC power applications may include a multiphase DC-DC converter in their power supply system. In some examples, a multiphase DC-DC converter may regulate an output voltage to a desired level while distributing the load current across several phases. By interleaving an operation of multiple phases, multiphase DC-DC converters may, for example, achieve higher current capacities and/or better transient response.

A multiphase DC-DC power converter may, for example, be controlled through feedback mechanisms. For example, a power controller of the multiphase DC-DC power converter may be configured to adjust the multiphase DC-DC power converter's operation based on an output voltage and current (e.g., of each phase and/or a combination of all the phases). For example, the power controller may include a voltage regulator (e.g., an error amplifier) to compare the output voltage with a reference voltage. The difference, or error, between these voltages may, for example, be used to generate a control signal that adjusts a duty cycle of the converter's phases. For example, the multiphase DC-DC power converter may include a feedback circuit configured to continuously measure the output voltage and/or current. Based on the measured output, the power controller may make real-time adjustments to keep the output voltage stable.

Pulse Width Modulation (PWM) is a widely used technique in the control of multiphase DC-DC power converters. A PWM control, for example, may include switching the power converter's transistors on and off at a selected frequency. For example, a ratio of an on-time of the phase to the total switching period (duty cycle) may determine an average output voltage of the converter. By varying the duty cycle, the output voltage of the converter may be regulated.

### SUMMARY

Apparatus and associated methods relate to a multi-mode multi-phase power control circuit (MMPC). In an illustrative example, the MMPC includes a scalable power phase (SPP) and at least one main power phase (MPP). The SPP, for example, may include a scaled inductor configured to enhance power efficiency in a low power mode. A power controller operably connected to the SPP and the MPP may generate a control signal to the SPP as a function of a user-defined scaling model including an output current scaling factor associated with a current mode of operation. For example, the SPP may be configured as a function of the scaling model, as a full current phase, a partial current phase, or a minimal current phase. Various embodiments may advantageously provide independently regulated power phases having a predetermined fraction of a current output of the MPP.

Various embodiments may achieve one or more advantages. For example, some embodiments may advantageously provide light load power supply efficiently. Some embodiments may, for example, advantageously include a current carrying capability different from the MPP configured to be used for light load applications. For example, some embodiments may advantageously provide a selection of the predetermined fraction independent of other phases and independent of inductances and DCR ratios across phases. Some embodiments, for example, may advantageously improve battery life. For example, some embodiments may advantageously provide independent adjustments of a transient response and power output of the SPP independently. Some embodiments, for example, may advantageously allow independent tuning a slow current balance gain of the SPP.

The details of various embodiments are set forth in the accompanying drawings and the description below. Other features and advantages will be apparent from the description and drawings, and from the claims.

### BRIEF DESCRIPTION OF THE DRAWINGS

FIG. 1A, FIG. 1B, and FIG. 1C depict an exemplary multimodal multiphase power module (MMPM) employed in an illustrative use-case scenario.

FIG. 2 is a block diagram depicting an exemplary independent scaling power controller (ISPC).

FIG. 3 depicts an exemplary electrical schematic of a four-phase power module having a scalable phase.

FIG. 4 depicts an exemplary electrical schematic of a two-mode two-phase power module having a scalable phase.

FIG. 5 is a flowchart illustrating an exemplary MMPM configuration method.

FIG. 6 is a block diagram depicting an exemplary independent scaling digital power controller (ISDPC).

FIG. 7 is a flowchart illustrating an exemplary MMPM control signal generation method.

Like reference symbols in the various drawings indicate like elements.

### DETAILED DESCRIPTION OF ILLUSTRATIVE EMBODIMENTS

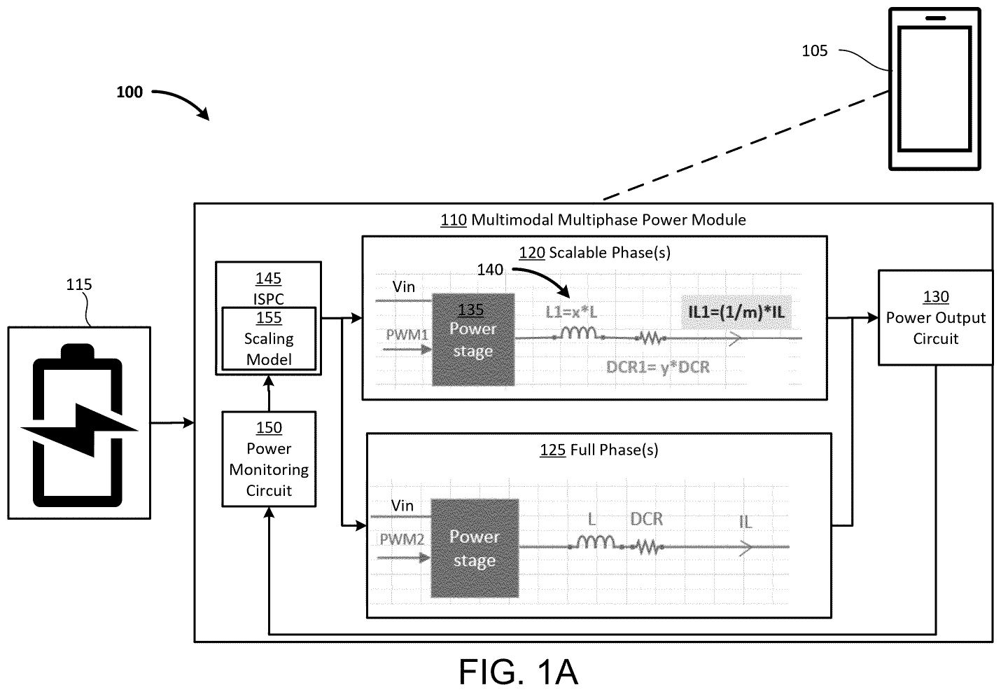

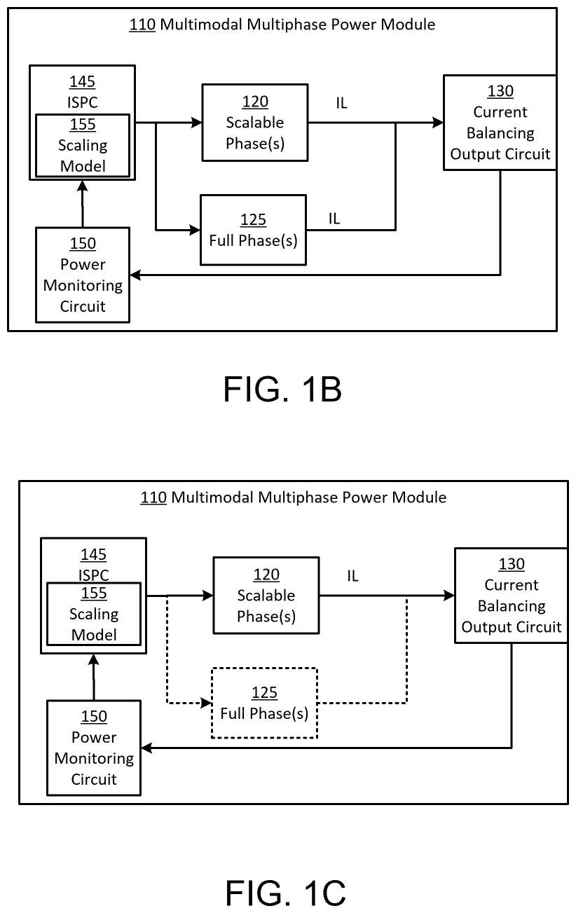

FIG. 1A, FIG. 1B, and FIG. 1C depict an exemplary multimodal multiphase power module (MMPM) employed in an illustrative use-case scenario. As shown in FIG. 1A, a direct current power system 100 includes a mobile device 105. The mobile device 105 includes a MMPM 110. Although the MMPM 110 is embedded in the mobile device 105, other applications including other computer devices, electric vehicles, data centers, large medical diagnostic equipment, light emitting diode lighting systems, DC microgrids, solar power system and/or other DC applications may include the MMPM 110. For example, the MMPM 110 may be implemented as an integrated circuit (IC) configured to control power supply to the mobile device 105. For example, the MMPM 110 may be implemented as a power supply chip.

In this example, the MMPM 110 is coupled to a DC power source 115. For example, the DC power source 115 may include a battery. In some embodiments, the MMPM 110 may also be used in non-battery powered applications (e.g., DC power supplies, DC power generators). For example, the MMPM 110 may receive power from the DC power source 115 to generate a regulated power for the mobile device 105.

The MMPM 110 includes multiple phases (a scalable phase 120 and a full phase 125). For example, the scalable phase 120 may include multiple scalable phases. For example, the full phase 125 may include multiple full phases. In some implementations, the scalable phase 120 and the full phase 125 may each generate a current (IL1, IL) to a power output circuit (POC 130). For example, the POC 130 may combine currents received from the scalable phase 120 and the full phase 125 to supply the mobile device 105.

In this example, the scalable phase 120 may be configured to supply power to the mobile device 105 in light load operations (e.g., during a stand-by mode of the mobile device 105). For example, the scalable phase 120 may include a separate baby buck channel configured to advantageously provide light load power supply efficiently. For example, the scalable phase 120 may be selectively configured to generate a fraction of an output current of the full phase 125 with a user-selected modulation gain.

As shown, the scalable phase 120 includes power stage 135 connected to a direct current resistance circuit (DCR circuit 140) including an inductor (L1) and a DCR resistor (DCR1). For example, the power stage 135 may receive a power (e.g., Vin) from the DC power source 115 to generate an output power based on a control signal (PWM1).

In some implementations, the power stage 135 may include a switched-mode power supply (SMPS) power stage. For example, the power stage 135 may be configured to convert electrical power from one form to another using switching devices (e.g., MOSFETs, IGBTs, other types of transistors) and/or energy storage components (e.g., inductors, transformers, capacitors). In some examples, the ISPC 145 may generate a control signal to the power stage 135 configured to rapidly switching an input power on and off to convert the input power to a predetermined output voltage and current.

In some implementations, the DCR circuit 140 may include asymmetrical inductors with different DCR compared to other phases of the MMPM 110. In this example, L1=x*L and DCR1=y*DCR, where L and DCR are inductance and resistance values of the inductor and DCR resistor of the full phase 125. For example, the scalable phase 120 may advantageously include a current carrying capability different from the full phase 125 configured to be used for light load applications.

In some implementations, the scalable phase 120 may be configured independent of the full phase 125 to include a specifically designed modulator gain. For example, an engineer may select x and y to achieve a desired modulator gain for the scalable phase 120. For example, when the inductor L1 is 4 times bigger than L, a natural response of the current output of the DCR circuit 140, without scaling, may be 4 times smaller than the current output (IL) of a DCR circuit of the full phase 125.

In this example, the MMPM 110 includes an independent scaling power controller (ISPC 145) configured to scale the output of the DCR circuit to a predetermined fraction of IL. As shown, an output current IL of the scalable phase 120 may be independently adjusted as (1/m) of IL, where m is an integer. In various embodiments, a value of m can be configured based on design choices of the engineer. As shown, the MMPM 110 includes a power monitoring circuit 150. For example, the

power monitoring circuit 150 may measure output (e.g., voltage and/or current) of the POC 130 and/or each phase (the scalable phase 120 and the full phase 125) of the MMPM 110 to generate an output sensing signal to the ISPC 145. In some implementations, the ISPC 145 may apply a scaling model 155 to the output sensing signal to generate control signals (e.g., the PWM1 and PWM2 in this example) to control power stages of the MMPM 110. In some embodiments, the power monitoring circuit may generate a current monitoring signal (Imon). For example, the ISPC 145 may generate the control signal based on Imon. For example, the ISPC 145 may generate the control signal to control the SMPS power stage as a function of the Imon.

In some embodiments, the scaling model 155 may be configured to scale an output of the power stage 135 to have an inductor current IL1 scaled at a predetermined fraction (1/m) compared to the other phase currents (e.g., the full phase 125). In some examples, the MMPM 110 may advantageously be used as either a small current channel, as a channel carrying full current as the full phase 125, or as any fraction of the currents from other phases of the MMPM 110 (e.g., the full phase 125). In some implementations, the scaling model 155 may advantageously provide a selection of m independent of other phases and independent of inductances and DCR ratios across phases.

As shown in FIG. 1B, the ISPC 145 may control the scalable phase 120, in a high power mode, as a full current carrying phase like the previous generation products (e.g., output of the scalable phase 120 is IL and same as the output of the full phase 125). In other examples, the ISPC 145 may control the scalable phase 120, in a medium power mode (e.g., for applications that are not using the full power capability of their additional phase), as a partial current phase. For example, using the scalable phase 120 as a partial current phase may advantageously provide light load efficiency benefit. For example, the light load efficiency may advantageously improve battery life.

As shown in FIG. 1C, the ISPC 145 may control the scalable phase 120, in a standby mode, as a phase carrying very small current. For example, the very small current may be just enough for keeping the mobile device 105 in a “sleep” mode to enable quick “wakeup” time, while providing a maximum energy efficiency.

As shown, the full phase 125 may be turned “off” in the standby mode, reducing energy consumption. In some examples, the scaling model 155 may be configured to improve energy efficiency in continuous conduction mode (CCM) and/or discontinuous conduction mode (DCM) at light load while not affecting a transient response of the MMPM 110 at heavy load. In some implementations, the MMPM 110 may include options for clock sequencing (e.g., running the scalable phase 120 in sequence or synchronous with other phases).

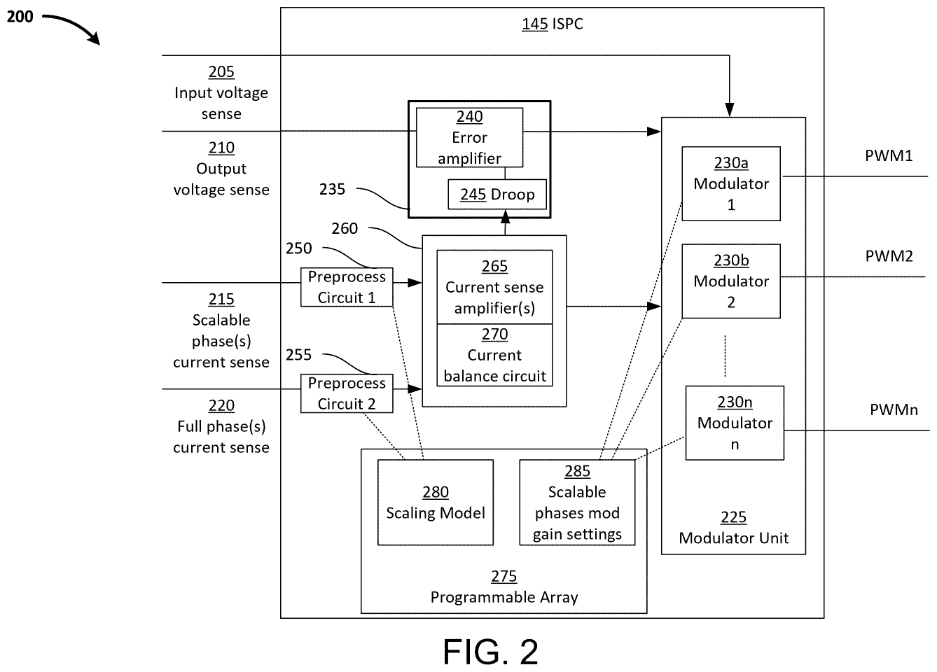

FIG. 2 is a block diagram depicting an exemplary independent scaling power controller (ISPC). For example, the ISPC 145 may be implemented as an analog IC. For example, the ISPC 145 may include an analog power controller IC. In this example, a MMPM 200 includes the ISPC 145. As shown, the ISPC 145 is configured to receive an input voltage sense 205 and an output voltage sense 210. For example, the input voltage sense 205 may be configured to measure an input voltage received from the DC power source 115. For example, the output voltage sense 210 may be configured to measure an output voltage of the POC 130.

In some implementations, the input voltage sense 205 and the output voltage sense 210 may be received from the power monitoring circuit 150. In some implementations, the SPCS input 215 and the FPCS input 220 may be received from the DCR circuit 140 of the scalable phase 120 and DCR circuits of the full phase 125, respectively.

The ISPC 145 includes a scalable phase(s) current sense input (SPCS input 215) and a full phase(s) current sense input (FPCS input 220). For example, the SPCS input 215 may include combined and/or individual current sense input from the scalable phase 120 of the MMPM 110. For example, the FPCS input 220 may include combined and/or individual current sense input from the full phase 125 of the MMPM 110.

The ISPC 145 includes a modulator unit 225. In some implementations, the modulator unit 225 may generate control signals (PWM1, PWM2, . . . , PWMn) to the power phases (1, 2, . . . , n) of the MMPM 110, each corresponding to one of the power phases. For example, the control signals may include pulse width modulation (PWM) signals. As shown, each of the control signals is generated by corresponding modulator circuit 230a, 230b, 230n. In some implementations, the modulator unit 225 may generate the control signal based on the input voltage sense 205, the output voltage sense 210, the SPCS input 215 and the FPCS input 220.

The ISPC 145 includes a voltage regulation circuit 235. For example, the voltage regulation circuit 235 may regulate a transient response of the MMPM 110 based on the output voltage sense 210. In this example, the voltage regulation circuit 235 includes an error amplifier 240 and a droop 245. For example, the error amplifier 240 may be configured to maintain an output voltage of the MMPM 110 at a predetermined level. For example, the droop 245 may be configured to maintain voltage under a varying load. For example, the droop 245 may allow for a controlled voltage drop when the output (load) current increases.

As shown, the ISPC 145 includes a first preprocess circuit 250 and a second preprocess circuit 255 to process the SPCS input 215 and the FPCS input 220, respectively. In some implementations, the first preprocess circuit 250 and the second preprocess circuit 255 may each be configured to apply a predetermined scaling factor (e.g., one or more scaling factors) to an input signal.

The ISPC 145 includes a current regulation circuit 260 configured to receive input signals (e.g., a scaled input signals of the SPCS input 215 and the FPCS input 220) from the first preprocess circuit 250 and the second preprocess circuit 255. For example, the current regulation circuit 260 may be configured to process current sense signals (e.g., the SPCS input 215 and the FPCS input 220) from each of the phases 1, . . . , n. The current regulation circuit 260 includes a current sense amplifier(s) (CSA 265) and a current balancing circuit (CBC 270).

For example, the CSA 265 may apply an amplification to the signals received from the first preprocess circuit 250 and the second preprocess circuit 255. For example, the CBC 270 may generate a balancing signal to the modulator unit 225 based on the amplified input signals.

As shown, the first preprocess circuit 250 and the second preprocess circuit 255 may receive a predetermined scaling model from programmable array 275 of the ISPC 145. For example, an engineer may store a scaling model 280 to be applied to each of the SPCS input 215 and the FPCS input 220 to the droop 245, for example, based on application needs. For example, the scaling model 280 may be applied to program the first preprocess circuit 250 and the second preprocess circuit 255. Based on the 280, the first preprocess circuit 250 and the second preprocess circuit 255 may be configured to apply the predetermined scaling factors to the SPCS input 215 and the FPCS input 220.

The programmable array 275, for example, may also store scalable phase modulator gain settings 285. For example, the scalable phase modulator gain settings 285 may be programmed to include a preselected modulator gain of scalable phase(s) (e.g., the scalable phase 120) of the MMPM 200. In some implementations, the modulator of each phase 230a, 230b, . . . , 230n may be configured to generate the control signal based on the scalable phase modulator gain settings 285 stored in the programmable array 275. As an illustrative example, the modulator unit 225 may independently generate the control signals to scalable phases so that the scalable phases generate a current output matching to a predetermined fraction of full phases as indicated by the scalable phase modulator gain settings 285.

In some implementations, the modulator unit 225 may generate a signal based on an operation mode defined by the scalable phase modulator gain settings 285. For example, in a normal mode, the modulator unit 225 may be configured to activate a scalable phase and the at least one main phase. For example, in a light load mode, the modulator unit 225 may be configured to activate the scalable phase and deactivate the at least one main phase.

In various implementations, a power controller may include programmable registers (e.g., the programmable array 275) configured to store a scaling vector (e.g., the scaling model 280) and a user-selected modulator gain (e.g., the scalable phase modulator gain settings 285). For example, the power controller may generate control signals to scalable phases of a power converter based on the user-selected modulator gain. For example, the power controller may be configured to regulate the scalable phases to generate a current at a predetermined fraction of full phases of the power converter based on the user-selected modulator gain. In some implementations, the power controller may adjust sense inputs (e.g., the SPCS input 215 and the FPCS input 220) from the power phases including, for example, the scalable phases and the full phases, with the scaling vector. For example, a current regulation circuit may receive input signals generated by applying the scaling vector to the sense input. Various embodiments may advantageously control a modulator gain of scalable phases independent of inductor and resistance values of the scalable phases.

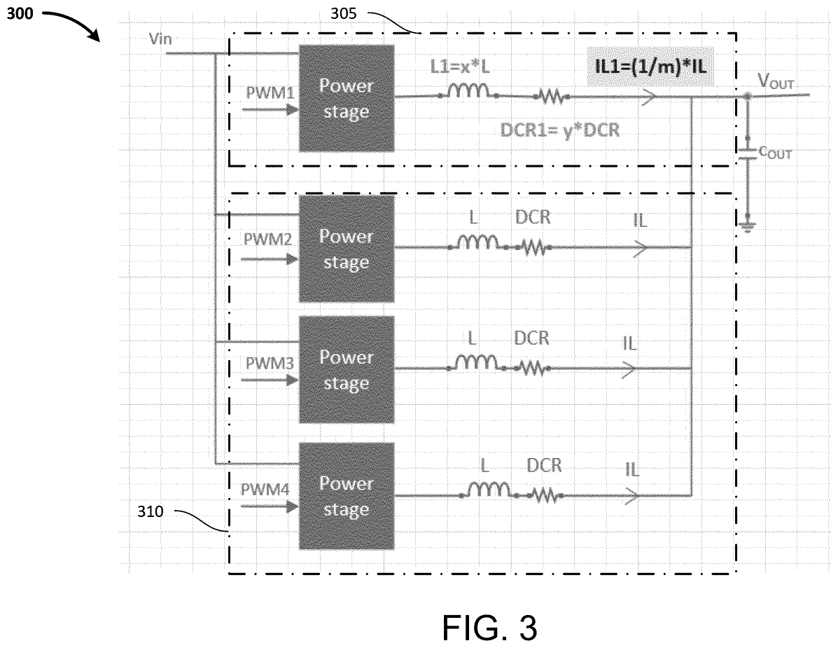

FIG. 3 depicts an exemplary electrical schematic of a four-phase power module having a scalable phase. In this example, a four-phase power module (FPM 300) includes a scalable phase 305 and three full phases 310. For example, the FPM 300 may be connected to the ISDPC 600. In some implementations, the ISDPC 600 may be configured to control the scalable phase 305 to be a phase that can carry full current or a reduced current. As shown, the scalable phase 305 may be controlled to generate an output current ILI as any ratio of an output current IL of the other phases, independent of the inductance and DCR values/ratios. For example, the FPM 300 coupled to the ISDPC 600 may advantageously include a full configuration flexibility to regulate IL1. For example, the ISDPC 600 connected to the FPM 300 may advantageously provide independent scaling of inductance L1, DCR1, and IL1. For example, the FPM 300 may advantageously provide independent adjustments of a transient response and power output of the SPP independently.

As an illustrative example without limitation, VIN=12V and VOUT=0.9V, for example. Ll of the scalable phase 305 may be L1=680 nH (˜150 nH*4.5) and DCR1=900μΩ*5.5. For example, inductors L1=150 nH, and DCR=900μΩ in each of the three full phases 310. By adjusting the scaling model 155, a phase 1 current (IL1) may be scaled to ⅛ of the other phases.

In various embodiments, the ISDPC 600 may allow an engineer to flexibly select from a wide range of inductors to achieve a desired ratio to each of the three full phases 310. For example, a current ratio m from the scalable phase 305 to a full phase 310 may be separately scaled.

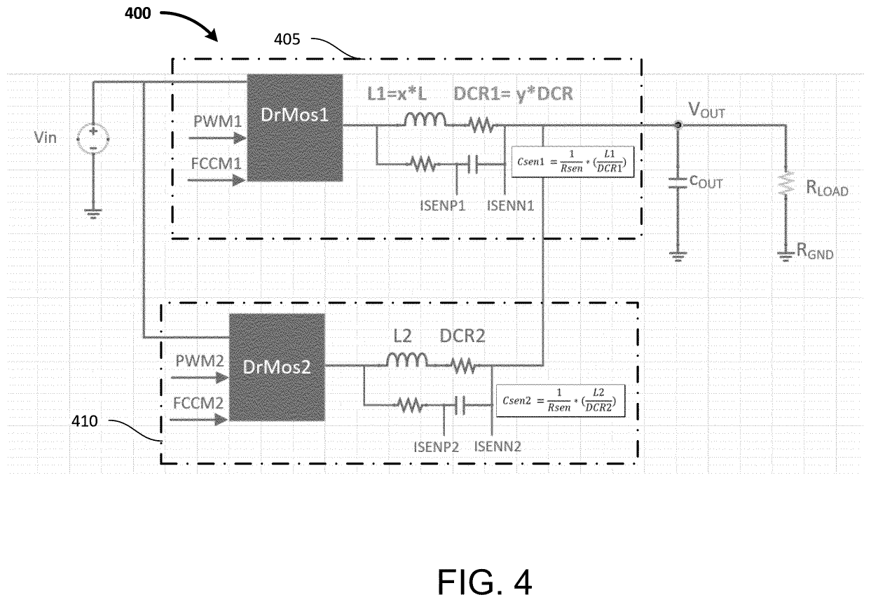

FIG. 4 depicts an exemplary electrical schematic of a two-mode two-phase power module having a scalable phase. In this example, a two-phase power drive (TPD 400) includes a scalable phase 405 and a full phase 410. The scalable phase 405 includes a first Driver-MOSFET (DrMOS). The full phase 410 includes a second DrMOS.

For example, an inductor current IL1, an inductor L1, and a DCRI of the scalable phase 405 may be set independently to any ratio of the full phase 410. In some implementations, the scalable phase 405 may include a DCR sense cap (Csens1) scaled to match a time constant of the full phase 410 (L/DCR). For example, the scalable phase 405 may include a modulator current gain as a function of an inductance variation between the scalable phase 405 and the full phase 410.

In some implementations, the TPD 400 may be connected to an ISPC (e.g., the ISDPC 600). For example, the ISDPC 600 may advantageously allow independent tuning a slow current balance gain (e.g., the IL1) of the scalable phase 405. In some implementations, the ISDPC 600 may further apply a first scaling factor to scale output of a fast current balance circuit for the scalable phase 405 with, for example, a predefined inductor current scaling ratio. In some implementations, the ISDPC 600 may apply a second scaling factor to scale output of a slow current balance circuit for the scalable phase 405.

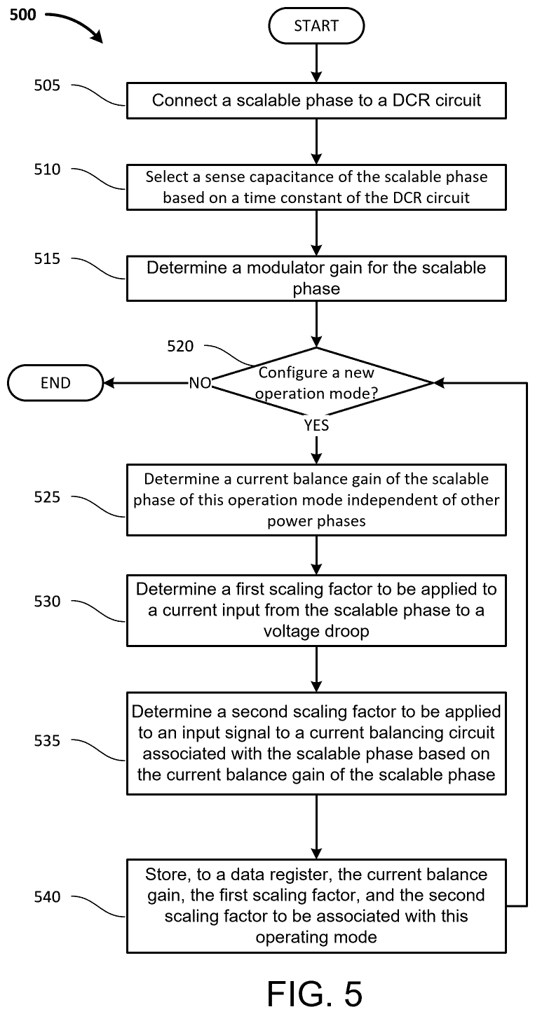

FIG. 5 is a flowchart illustrating an exemplary MMPM configuration method. In this example, a method 500 may be performed by an engineer to configure a MMPM (e.g., using the user interface 615 to interface with the ISDPC 600). For example, the engineer may use the user interface 615 to fine tune the scaling model 155 based on a response of the MMPM 110. In this example, the method 500 begins when a scalable phase is connected to a DCR circuit in step 505. For example, the engineer may connect a DCR circuit with an inductance x*L and resistance y*DCR to the scalable phase 120, where L and DCR are inductance and resistance of a DCR circuit of other phases of the MMPM 110.

In step 510, a sense capacitance of the scalable phase is selected based on a time constant matching of the DCR circuit. For example, the engineer may select a capacitance value that matches a time constant of the DCR circuit connected in step 505.

In step 515, a modulator gain for the scalable phase is determined. For example, the engineer may calculate a modulator gain required for the scalable phase based on inductance variation. At a decision point 520, it is determined whether a new operation mode is needed to be configured. If no new operation mode is to be configured, the method 500 ends.

If a new operation mode is to be configured, in step 525, a current balance gain of the scalable phase is determined independently of other power phases. For example, the engineer may set a current balance gain specific to the scalable phase without affecting other phases.

In step 530, a first scaling factor is determined to be applied to a current input from the scalable phase to a voltage droop. For example, the engineer may calculate the scaling factor to ensure proper voltage droop compensation. In step 535, a second scaling factor is determined to be applied to an input signal to a current balancing circuit associated with the scalable phase based on the current balance gain of the scalable phase. For example, the engineer may set the scaling factor to be applied to an input of the POC 130. In step 540, the current balance gain, the first scaling factor, and the second scaling factor are stored to a data register to be associated with this operating mode, and the decision point 520 is repeated. For example, the engineer may save these parameters to the programmable array 275.

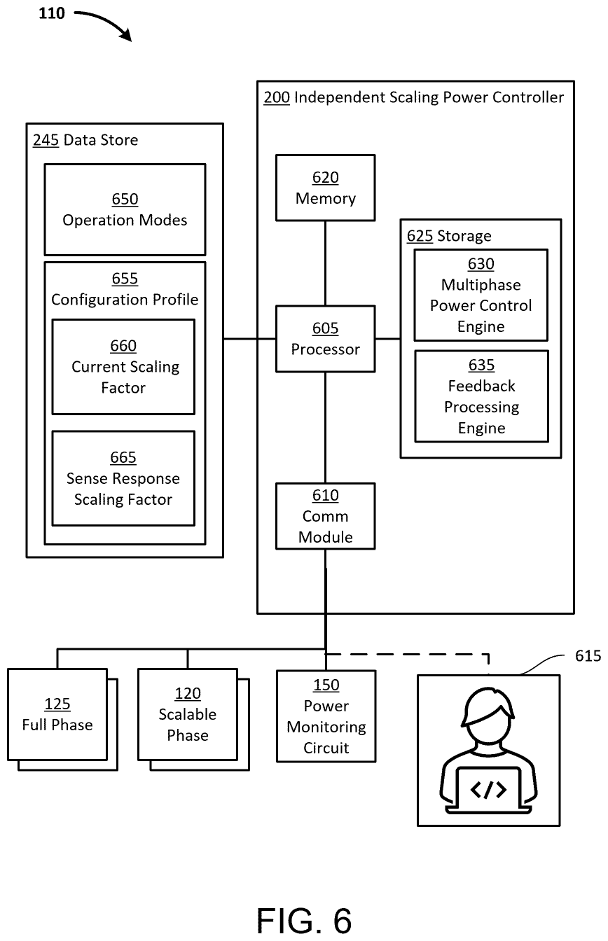

FIG. 6 is a block diagram depicting an exemplary independent scaling digital power controller (ISDPC). In this example, an ISDPC 600 includes a processor 605. The processor 605 may, for example, include one or more processing units. The processor 605 is operably coupled to a communication module 610. The communication module 610 may, for example, include wired communication. The communication module 610 may, for example, include wireless communication. In the depicted example, the communication module 610 is operably coupled to the power monitoring circuit 150. For example, the ISDPC 600 may generate output signals (e.g., PWM signals) to the scalable phase 120 and the full phase 125.

In this example, the communication module 610 is operably (and/or optionally) coupled to a user interface 615. For example, the user interface 615 may include turning knobs. For example, the user interface 615 may include a web interface. For example, the user interface 615 may include a graphical user interface shown on a computing device temporarily (and/or releasably) coupled to the ISDPC 600. In some implementations, the user interface 615 is configured to adjust a scaling factor of the output current of the scalable phase 120 in one or more operation modes.

The processor 605 is operably coupled to a memory module 620. The memory module 620 may, for example, include one or more memory modules (e.g., random-access memory (RAM)). The processor 605 includes a storage module 625. The storage module 625 may, for example, include one or more storage modules (e.g., non-volatile memory). In the depicted example, the storage module 625 includes a multiphase power control engine (MPCE 630) and a feedback processing engine (FPE 635). For example, the MPCE 630 may be configured to generate control signals to power phases (e.g., the scalable phase 120 and the full phase 125) connected to the ISDPC 600. For example, the FPE 635 may be configured to regulate a transient response (e.g., a transient voltage response of the MMPM 110).

The processor 605 is further operably coupled to a data store 645. For example, the data store 645 may include data registers. For example, the data store 645 may receive input from the user interface 615. In some implementations, the data store 645 may include a programmable IC. The data store 645 includes operation modes 650 and a configuration profile 655. The configuration profile 655 includes a current scaling factor 660 and a sense response scaling factor 665. For example, the current scaling factor 660 and the sense response scaling factor 665 may be pre-configured by the engineer using the user interface 615 during a configuration method (e.g., in various methods described with reference to FIG. 5).

For example, the MPCE 630 may apply the current scaling factor 660 to scale an output current of the scalable phase 120. In some examples, the FPE 635 may apply the sense response scaling factor 665 to a feedback signal received from the power monitoring circuit 150. For example, the power monitoring circuit 150 may include a circuit configured to generate an emulated current signal as a function of, for example, an average of all phases of the direct current power system 100. In some implementations, the power monitoring circuit 150 may include a current sense amplifier. For example, the sense response scaling factor 665 may include a factor to scale voltage from the current sense amplifier with the DCR ratio of the scalable phase 120.

In some embodiments, the configuration profile 655 may include more than one configuration profile 655, each including a different value for the current scaling factor 660 and sense response scaling factor 665. For example, each configuration profile 655 may be associated with one of the operation modes 650. For example, the MPCE 630 may select and apply the configuration profile 655 based on a currently selected operation mode. For example, the MPCE 630 may be configured to regulate the scalable phase 120 to generate a different output current IL based on the currently selected operation mode (e.g., as a full current phase configured to generate the current output having a magnitude substantially same as the current output the full phase 125, as a partial current phase configured to generate the current output having the magnitude with a predetermined fraction of the current output the full phase 125, as a phase carrying very small current). For example, the MPCE 630 may be configured to adjust a frequency in an one-phase mode (e.g., in a standby mode as described with reference to FIG. 1C) may be tuned to enhance efficiency.

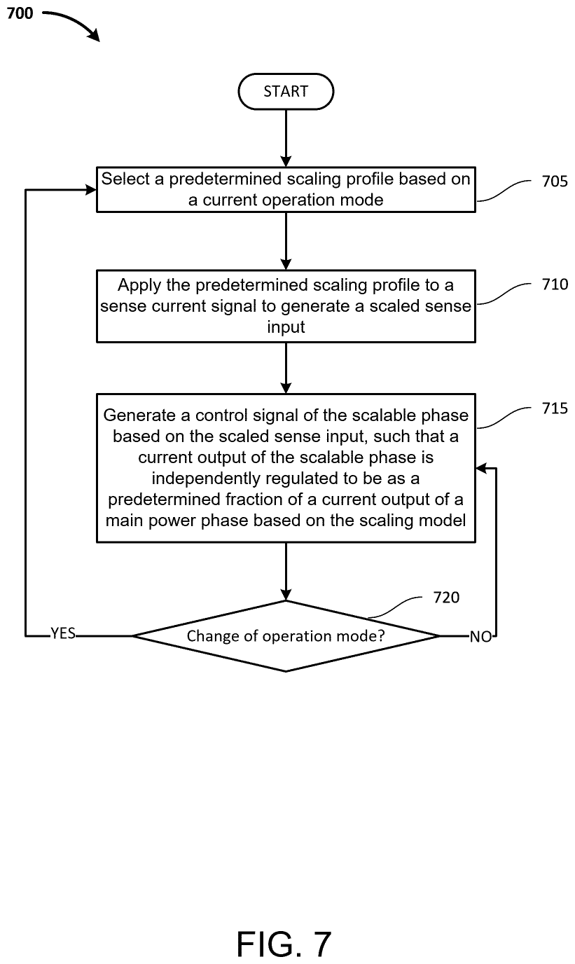

FIG. 7 is a flowchart illustrating an exemplary MMPM control signal generation method. For example, a method 700 may be performed by the ISDPC 600 in controlling the scalable phase 120. In this example, the method 700 begins in step 705 when a predetermined scaling profile is selected based on a current operation mode. For example, the ISDPC 600 may retrieve the operation modes 650 associated with a current operation mode.

In step 710, the predetermined scaling profile is applied to a sense current signal to generate a scaled sense input. For example, the ISDPC 600 may apply the scaling model 155 to the output sensing signal received from the power monitoring circuit 150. In step 715, a control signal of the scalable phase is generated based on the scaled sense input such that a current output of the scalable phase is independently regulated to be as a predetermined fraction of a current output of a main power phase based on the scaling model. For example, the ISDPC 600 may generate a control signal to generate IL1 as a predetermined fraction (1/m) of IL as described in FIGS. 1A-4.

At a decision point 720, it is determined whether there is a change in the operation mode. For example, a user may change the operation mode of the mobile device 105 from normal to a standby mode. If there is a change, the method 700 returns to step. If there is no change, the step 715 is repeated. For example, the ISDPC 600 may continue to apply the current control strategy.

Although various embodiments have been described with reference to the figures, other embodiments are possible. For example, the scalable phase 120 may be a 1st phase of the MMPM 110. In some examples, the scalable phase 120 may be other phases (e.g., 2, 3, 4, 5, 6) of the MMPM 110.

In some implementations, the MMPM 110 may include a buck converter. In some embodiments, the MMPM 110 may include other DC-DC converters in other topologies. For example, the MMPM 110 may include a current sense circuit. For example, the MMPM 110 may include an emulated inductor current circuit.

In some implementations, the ISPC 145 may include various modulation and/or control schemes to generate control signals. For example, the ISPC 145 may generate control signals using Pulse Width Modulation (PWM), Space Vector Pulse Width Modulation (SVPWM), Sinusoidal Pulse Width Modulation (SPWM), hysteresis control, Current Mode Control (CMC), Voltage Mode Control (VMC), Sliding Mode Control (SMC), predictive control, Direct Torque Control (DTC), Phase Shift Modulation (PSM), Field-Oriented Control (FOC), delta modulation, Frequency Modulation (FM), Amplitude Modulation (AM), Pulse Density Modulation (PDM), and/or a combination thereof.

In some implementations, the ISPC 145 may include various current balancing methodologies. For example, the ISPC 145 may implement current balancing using Active Current Balancing, Passive Current Balancing, Digital Current Balancing, Hysteresis-Based Current Balancing, Phase Shedding, Droop Control, Average Current Mode Control, Peak Current Mode Control, Adaptive Current Balancing, Feedforward Current Balancing, and/or a combination thereof.

In some implementations, the ISPC 145 may include various phase interleaving methodologies. For example, the ISPC 145 may implement phase interleaving using Fixed Phase Interleaving, Variable Phase Interleaving, Adaptive Phase Interleaving, Digital Phase Interleaving, Analog Phase Interleaving, Synchronous Phase Interleaving, Asynchronous Phase Interleaving, Phase Skipping, Sequential Phase Interleaving, Random Phase Interleaving, and/or a combination thereof.

For example, the MMPM 110 may include various current sense schemes (e.g., sense resistor, on-resistance (RdsON), Smart power stage). Various embodiments may include a scaling model determined to be applied to a current sense voltage to generate user-selected response for the scalable phase 120.

Although an exemplary system has been described with reference to the figures, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

Temporary auxiliary energy inputs may be received, for example, from chargeable or single use batteries, which may enable use in portable or remote applications. Some embodiments may operate with other DC voltage sources, such as a (nominal) batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device. The display device may, for example, include an LED (light-emitting diode) display. In some implementations, a display device may, for example, include a CRT (cathode ray tube). In some implementations, a display device may include, for example, an LCD (liquid crystal display). A display device (e.g., monitor) may, for example, be used for displaying information to the user. Some implementations may, for example, include a keyboard and/or pointing device (e.g., mouse, trackpad, trackball, joystick), such as by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IOT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAs, ASICs), or some combination thereof. In some embodiments, the module(s) may involve execution of preprogrammed instructions, software executed by a processor, or some combination thereof. For example, various modules may involve both hardware and software.

In an illustrative aspect, a multi-mode multi-phase power control circuit may include a plurality of power phases. For example, the plurality of power phases may include a main power phase configured to receive a power input to generate a main current output. For example, the plurality of power phases may include a scalable power phase configured to receive the power input to generate a scalable current output.

For example, the multi-mode multi-phase power control circuit may include a power controller coupled to the main power phase and the scalable power phase in parallel. For example, the scalable power phase may include a modulator current gain different from the main power phase. For example, the power controller may be configured to generate a control signal to the scalable power phase as a function of a scaling model may include an output current scaling factor associated with a current mode of operation, and the modulator current gain. For example, the scalable current output may be independently regulated as a predetermined fraction of the main current output based on the scaling model. For example, based on the current mode of operation, the scalable power phase may be configurable as a function of the scaling model to a full current phase. For example, the predetermined fraction may be 1 and may be configured to generate the current output having a magnitude substantially same as the current output of the main power phase.

For example, based on the current mode of operation, the scalable power phase may be configurable as a function of the scaling model to a partial current phase. For example, the predetermined fraction may be less than 1.

For example, based on the current mode of operation, the scalable power phase may be configurable as a function of the scaling model to generate the current output having the magnitude with the predetermined fraction of the current output of the main power phase that a minimal phase carrying minimal current configured to maintain operations in a forced continuous conduction mode.

For example, the scalable power phase and the main power phase each may include a direct current resistance (DCR) circuit, and the modulator current gain may include a predetermined relationship between a ratio of DCR ratios of the DCR circuits of the scalable power phase and the main power phase.

For example, the main power phase may include two or more power stages.

For example, the plurality of power phases may include a switch mode power supply (SMPS) power stage. For example, the power controller may be configured to generate the control signal based on a current monitoring signal (Imon) generated based on an output current of the SMPS power stage.

For example, the scaling model may include a voltage regulation scaling factor configured to be applied to a voltage received from a power monitoring circuit. For example, the scaling model may include a current scaling model. For example, the current scaling model may include a first scaling factor configured to scale an output of a transient power output circuit of the scalable power phase with an inductor current scaling ratio. For example, the current scaling model may include a second scaling factor configured to scale an output of a steady-state power output circuit of the scalable power phase.

For example, the power monitoring circuit may include a droop. For example, a current input of the scalable power phase to the droop may be scaled by the voltage regulation scaling factor.

For example, the mode of operation may include a normal mode. For example, the power controller may be configured to generate a first overall output current may include the scalable current output and the main current output. For example, the mode of operation may include a light load mode. For example, the power controller may be configured to generate a second overall output current that may include only the scalable current output.

For example, the power controller may include a current sense input circuit configured to receive current sense signals from all phases and generate an emulated current sense signal.

In an illustrative aspect, a multi-mode multi-phase phase power controller may include a modulator gain generation circuit configured to generate modulator gain signals to each of a plurality of power phases coupled to the modulator gain generation circuit. For example, the multi-mode multi-phase phase power controller may include an output regulation circuit configured to process feedback signals. For example, the output regulation circuit may include a current received from the plurality of power phases, and generate regulation signals to the modulator gain generation circuit.

For example, the plurality of power phases may include a scalable phase and a full phase. For example, the feedback signals may include a current sense signal received from the scalable phase. For example, the multi-mode multi-phase phase power controller may include a programmable array coupled to the modulator gain generation circuit and the output regulation circuit. For example, the programmable array may include data registers configured to store a scaling model and a modulator gain setting. For example, the modulator gain generation circuit may be configured to generate the modulator gain signals based on the modulator gain setting and a first processed feedback signal generated as a function of the feedback signals and the scaling model. For example, a scalable current output generated by the scalable phase may be independently regulated as a predetermined fraction of a full current output of the full phase.

For example, the feedback signals may include a sense current signal generated by a direct current resistance (DCR) circuit of each of the plurality of power phases.

For example, the scalable phase may include two or more power phases.

For example, the plurality of power phases may include a switch mode power supply (SMPS) power stage. For example, the power controller may be configured to generate the control signal based on a current monitoring signal (Imon) generated based on an output current of the SMPS power stage.

For example, based on the modulator gain setting, the modulator gain generation circuit may be configured to regulate the scalable phase as a full current phase. For example, the predetermined fraction may be 1 and may be configured to generate the current output having a magnitude substantially same as the current output of the main power phase.

For example, based on the modulator gain setting, the modulator gain generation circuit may be configured to regulate the scalable phase as a partial current phase. For example, the predetermined fraction may be less than 1 and may be configured to generate the current output having the magnitude with the predetermined fraction may be of the current output the main power phase. For example, based on the modulator gain setting, the modulator gain generation circuit may be configured to regulate the scalable phase as a minimal phase carrying minimal current configured to maintain operations in a forced continuous conduction mode.

For example, the scaling model may include a first scaling factor configured to scale a current sense signal received from the scalable phase. For example, the scaling model may include a second scaling factor configured to scale a current sense signal received from the full phase.

For example, the power controller may be configured to operate in at least two modes. For example, in a normal mode, the power controller may be configured to activate the scalable phase and the at least one main phase. For example, in a light load mode, the power controller may be configured to activate the scalable phase and deactivate the at least one main phase.

For example, the power monitoring circuit may include voltage regulation circuit may include a droop. For example, the droop may be configured to generate a transient control signal as a function of a second processed feedback signal generated as a function of the feedback signal and the scaling model.

For example, the multi-mode multi-phase phase power controller may include a preprocess circuit configured to receive the feedback signals. For example, a current sense processing circuit may include a current balance circuit and a current sense amplifier, and coupled to the preprocess circuit. For example, the current sense processing circuit may be configured to generate modulator control signals to the modulator gain generation circuit as a function of the feedback signals.

In an illustrative aspect, a scalable phase configuration method for a power converter may include connect a scalable phase to a current sensing circuit. For example, the scalable phase may include a direct current resistance circuit (DCR circuit). For example, the DCR circuit may include a sense capacitor, a DCR, and an inductor. For example, the DCR and the inductor may each include a predetermined relationship with a second DCR and a second inductor of current sensing circuits of at least one main power phase of the power converter.

For example, the scalable phase configuration method may include select a sense capacitance to match a time constant of the scalable phase. For example, the scalable phase configuration method may include determine a modulator gain for the scalable phase as a function of the inductor of the DCR circuit. For example, the scalable phase configuration method may include determine a current balance gain of the scalable phase independent of other power phases. For example, the scalable phase configuration method may include determine a first scaling factor to be applied to a current input from the scalable phase to a voltage droop.

For example, the scalable phase configuration method may include determine a second scaling factor to be applied to an input signal to a current balancing circuit associated with the scalable phase based on the current balance gain of the scalable phase. For example, the current balancing circuit is configured to generate an overall output current of the power converter.

For example, the scalable phase configuration method may include store, to a data register, the current balance gain, the first scaling factor, and the second scaling factor to be associated with an operating mode, such that a ratio between output currents of the scalable phase and other phases of the power converter is independently configured.

For example, the scalable phase configuration method may include select a clock sequencing mode having an in sequence mode and a synchronous mode. For example, the current balance gain is determined based on the selected clock sequencing mode.

For example, the operating mode may include at least three modes. For example, in a first mode, the scalable phase is configured as a full current phase generating a current output having a magnitude substantially same as a current output of the at least one main power phase. For example, in a second mode, the scalable phase is configured as a partial current phase configured to generate the current output having the magnitude with a predetermined fraction of the current output of the at least one main power phase. For example, in a third mode, the scalable phase is configured as a phase carrying minimal current configured to maintain the power converter in a forced continuous conduction mode.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A multi-mode multi-phase power control circuit comprising:
a plurality of power phases comprises:
a main power phase configured to receive a power input to generate a main current output; and,
a scalable power phase configured to receive the power input to generate a scalable current output; and,
a power controller coupled to the main power phase and the scalable power phase in parallel, wherein:
the scalable power phase comprises a modulator current gain different from the main power phase; and,
the power controller is configured to generate a control signal to the scalable power phase as a function of a scaling model comprising an output current scaling factor associated with a current mode of operation, and the modulator current gain, such that the scalable current output is independently regulated as a predetermined fraction of the main current output based on the scaling model, wherein, based on the current mode of operation, the scalable power phase is configurable as a function of the scaling model to one of:
a full current phase, wherein the predetermined fraction is 1, configured to generate the current output having a magnitude substantially same as the current output the main power phase;
a partial current phase, wherein the predetermined fraction is less than 1, configured to generate the current output having the magnitude with the predetermined fraction is of the current output the main power phase; and,
a minimal phase carrying minimal current configured to maintain operations in a forced continuous conduction mode.

2. The multi-mode multi-phase power control circuit of claim 1, wherein the scalable power phase and the main power phase each comprises a direct current resistance (DCR) circuit, and the modulator current gain comprises a predetermined relationship between a ratio of DCR ratios of the DCR circuits of the scalable power phase and the main power phase.

3. The multi-mode multi-phase power control circuit of claim 1, wherein the main power phase comprises two or more power stages.

4. The multi-mode multi-phase power control circuit of claim 1, wherein the plurality of power phases comprises a switch mode power supply (SMPS) power stage, wherein the power controller is configured to generate the control signal based on a current monitoring signal (Imon) generated based on an output current of the SMPS power stage.

5. The multi-mode multi-phase power control circuit of claim 1, wherein the scaling model comprises:
a voltage regulation scaling factor configured to be applied to a voltage received from a power monitoring circuit; and,
a current scaling model comprises:
a first scaling factor configured to scale an output of a transient power output circuit of the scalable power phase with an inductor current scaling ratio; and,
a second scaling factor configured to scale an output of a steady-state power output circuit of the scalable power phase.

6. The multi-mode multi-phase power control circuit of claim 5, wherein the power monitoring circuit comprises a droop, wherein a current input of the scalable power phase to the droop is scaled by the voltage regulation scaling factor.

7. The multi-mode multi-phase power control circuit of claim 1, wherein the mode of operation comprises:
a normal mode, wherein the power controller is configured to generate a first overall output current comprising the scalable current output and the main current output; and,
a light load mode, wherein the power controller is configured to generate a second overall output current comprising only the scalable current output.

8. The multi-mode multi-phase power control circuit of claim 1, wherein the power controller comprises a current sense input circuit configured to receive current sense signals from all phases and generate an emulated current sense signal.

9. A multi-mode multi-phase phase power controller comprising:
a modulator gain generation circuit configured to generate modulator gain signals to each of a plurality of power phases coupled to the modulator gain generation circuit;
an output regulation circuit configured to process feedback signals comprising a current received from the plurality of power phases, and generate regulation signals to the modulator gain generation circuit, wherein:
the plurality of power phases comprises a scalable phase and a full phase; and,
the feedback signals comprise a current sense signal received from the scalable phase;
a programmable array coupled to the modulator gain generation circuit and the output regulation circuit, wherein the programmable array comprises data registers configured to store a scaling model and a modulator gain setting, wherein the modulator gain generation circuit is configured to generate the modulator gain signals based on the modulator gain setting and a first processed feedback signal generated as a function of the feedback signals and the scaling model, such that a scalable current output generated by the scalable phase is independently regulated as a predetermined fraction of a full current output of the full phase.

10. The multi-mode multi-phase phase power controller of claim 9, wherein the feedback signals comprises a sense current signal generated by a direct current resistance (DCR) circuit of each of the plurality of power phases.

11. The multi-mode multi-phase phase power controller of claim 9, wherein the scalable phase comprises two or more power phases.

12. The multi-mode multi-phase phase power controller of claim 9, wherein the plurality of power phases comprises a switch mode power supply (SMPS) power stage, wherein the power controller is configured to generate the control signal based on a current monitoring signal (Imon) generated based on an output current of the SMPS power stage.

13. The multi-mode multi-phase phase power controller of claim 9, wherein, based on the modulator gain setting, the modulator gain generation circuit is configured to regulate the scalable phase as one of:
a full current phase, wherein the predetermined fraction is 1, configured to generate the current output having a magnitude substantially same as the current output the main power phase;
a partial current phase, wherein the predetermined fraction is less than 1, configured to generate the current output having the magnitude with the predetermined fraction is of the current output the main power phase; and,
a minimal phase carrying minimal current configured to maintain operations in a forced continuous conduction mode.

14. The multi-mode multi-phase phase power controller of claim 9, wherein the scaling model comprises:
a first scaling factor configured to scale a current sense signal received from the scalable phase; and,
a second scaling factor configured to scale a current sense signal received from the full phase.

15. The multi-mode multi-phase phase power controller of claim 9, wherein the power controller is configured to operate in at least two modes, wherein:
in a normal mode, the power controller is configured to activate the scalable phase and the at least one main phase; and,
in a light load mode, the power controller is configured to activate the scalable phase and deactivate the at least one main phase.

16. The multi-mode multi-phase phase power controller of claim 14, wherein the power monitoring circuit comprises voltage regulation circuit comprising a droop, wherein the droop is configured to generate a transient control signal as a function of a second processed feedback signal generated as a function of the feedback signal and the scaling model.

17. The multi-mode multi-phase phase power controller of claim 9, wherein further comprises:
a preprocess circuit configured to receive the feedback signals; and,
a current sense processing circuit comprising a current balance circuit and a current sense amplifier, and coupled to the preprocess circuit, wherein the current sense processing circuit is configured to generate modulator control signals to the modulator gain generation circuit as a function of the feedback signals.

18. A scalable phase configuration method for a power converter comprising:
connect a scalable phase to a current sensing circuit comprising a direct current resistance circuit (DCR circuit), wherein the DCR circuit comprises a sense capacitor, a DCR, and an inductor, wherein the DCR and the inductor are each comprises a predetermined relationship with a second DCR and a second inductor of current sensing circuits of at least one main power phase of the power converter;
select a sense capacitance to match a time constant of the scalable phase;
determine a modulator gain for the scalable phase as a function of the inductor of the DCR circuit;
determine a current balance gain of the scalable phase independent of other power phases;
determine a first scaling factor to be applied to a current input from the scalable phase to a voltage droop;
determine a second scaling factor to be applied to an input signal to a current balancing circuit associated with the scalable phase based on the current balance gain of the scalable phase, wherein the current balancing circuit is configured to generate an overall output current of the power converter; and,
store, to a data register, the current balance gain, the first scaling factor, and the second scaling factor to be associated with an operating mode, such that a ratio between output currents of the scalable phase and other phases of the power converter is independently configured.

19. The scalable phase configuration method of claim 18, further comprises select a clock sequencing mode comprising a in sequence mode and a synchronous mode, wherein the current balance gain is determined based on the selected clock sequencing mode.

20. The scalable phase configuration method of claim 18, wherein the operating mode comprises at least three modes:
in a first mode, the scalable phase is configured as a full current phase generating a current output having a magnitude substantially same as a current output of the at least one main power phase;
in a second mode, the scalable phase is configured as a partial current phase configured to generate the current output having the magnitude with a predetermined fraction of the current output of the at least one main power phase; or,
in a third mode, the scalable phase is configured as a phase carrying minimal current configured to maintain the power converter in a forced continuous conduction mode.
